(19) United States
(12) Patent Application Publication
(10) Pub. No.: US 2025/0337041 A1
(43) Pub. Date: Oct. 30, 2025

(54) THERMAL REGULATION DEVICE FOR COOLING AN ELECTRICAL ENERGY STORAGE MEMBER

(71) Applicant: VALEO SYSTEMES THERMIQUES, Le Mesnil-Saint-Denis (FR)

(72) Inventors: Emmanuel Henon, Le Mesnil-Saint-Denis Cedex (FR); Nicolas Levasseur, Le Mesnil-Saint-Denis Cedex (FR); Stephan Andre, Le Mesnil-Saint-Denis Cedex (FR); Sergio Da-costa-pito, Le Mesnil-Saint-Denis Cedex (FR)

(73) Assignee: VALEO SYSTEMES THERMIQUES, Le Mesnil-Saint-Denis (FR)

(21) Appl. No.: 18/865,253

(22) PCT Filed: Apr. 28, 2023
(86) PCT No.: PCT/EP2023/061265

§ 371 Date: Nov. 12, 2024

(30) Foreign Application Priority Data
May 12, 2022 (FR) FR2204533

(51) Int. Cl. H01M 10/6556; H01M 10/613; H01M 10/647; H01M 10/6568

(52) U.S. Cl. CPC H01M 10/6556; H01M 10/613; H01M 10/647; H01M 10/6568

(57) ABSTRACT

A thermal regulation device for cooling of an energy storage unit, including a first stage and a second stage. The first stage includes a first support plate and a first distribution plate. The thermal regulation device includes at least one additional plate positioned against the first support plate, and delimiting at least one duct for circulation of the cooling fluid. The first stage and the second stage are in fluidic communication via the additional plate and a connection means.

The present invention concerns the field of thermal regulation devices, and more particularly the means implemented for regulation of the temperature of electrical energy storage units with which vehicles are equipped.

Nowadays, it is known for electric, thermal or hybrid vehicles to be equipped with electrical energy storage units permitting supply of electric power to the different elements of the vehicle. These electrical energy storage units are generally composed of electrical energy storage cells positioned in a battery pack.

When the vehicle is running, the battery packs can release a large quantity of heat and consequently be subjected to temperature increases that can in certain cases damage or even destroy them. Therefore, their cooling is essential in order to keep them in good condition and thus to ensure the reliability, autonomy and performance level of the vehicle. Furthermore, the operation of the battery packs can be less efficient in the event of low temperatures, with the electrical or electronic components equipping these battery packs then needing time to build up temperature before operating at full capacity.

For this purpose, one or more thermal regulation devices designed to regulate the temperature of the battery packs are implemented so as to assure the heating and/or cooling functions of the electrical or electronic components inside these battery packs and to thus optimize the operation of the different components.

These thermal regulation devices generally have passing through them a thermal regulation fluid which can, according to requirements, either absorb the heat emitted by each battery pack in order to cool it or supply heat if the temperature of the battery pack is insufficient for good operation thereof.

The thermal regulation devices can be constituted for example by a flat plate on which there is added a stamped plate, such as to form, between the flat plate and reliefs formed in the stamped plate, channels which are designed to have the thermal regulation fluid passing through them. This type of thermal regulation device generally extends over all of the surface formed by the corresponding battery pack, and the plate is arranged in the battery pack such that each of the storage cells can be positioned against the plate, so that the thermal regulation fluid circulating in the channels of the thermal regulation device can exchange calories with the assembly of the electrical energy storage cells.

Motor vehicle manufacturers are nowadays seeking to supply more powerful electric or hybrid vehicles, and which have increased electrical autonomy. For this purpose, more and more battery packs, and/or larger and larger battery packs, are installed on these electric or hybrid vehicles.

Thus, the electrical energy storage cells of a single battery pack can be distributed over two stages of this battery pack, such as to optimize the space necessary for installation of the battery pack within the vehicle it equips.

It is therefore necessary to circulate the thermal regulation fluid within these two stages, for example a first stage and a second stage. It is possible for the thermal regulation properties of the thermal regulation fluid to be reduced if this cooling fluid circulates within the thermal regulation device, such that it cools the electrical energy storage cells positioned on the first stage before cooling the electrical energy storage cells positioned on the second stage, or conversely. It is understood that circulation of this type of the thermal regulation fluid, in order to cool the two stages in succession, would give rise to excessive heating of the thermal regulation fluid, which would reduce its thermal regulation properties when it should be regulating the temperature of the electrical energy storage cells positioned on the second stage.

The objective of the present invention is to eliminate this disadvantage by proposing a thermal regulation device which makes it possible to cool a first stage and a second stage of a single battery pack by means of a single cooling fluid closed circuit, which permits circulation of the thermal regulation fluid within the first stage without this fluid being allocated to cooling of the electrical energy storage cells of the second stage, thus permitting optimal cooling of the electrical energy storage cells of the second stage.

The main objective of the present invention is thus a thermal regulation device for cooling of an energy storage device by a cooling fluid, comprising a first stage which is configured to be in contact with a first portion of the energy storage unit, and a second stage which is configured to be in contact with a second portion of the energy storage unit, the second stage being at least partly offset in relation to the first stage in a vertical direction of stacking, the first stage comprising a first support plate and a first distribution plate, the first support plate having a first face which is designed to be in contact with the energy storage unit, and a second face opposite this first face, the first distribution plate being in contact with this second face, and being deformed locally such as to delimit channels for circulation of the cooling fluid. According to the invention, the thermal regulation device comprises at least one additional plate positioned against the first face of the first support plate, and delimiting at least one duct for circulation of the cooling fluid, the first stage and the second stage being in fluidic communication via the additional plate and a connection means.

The thermal regulation device according to the invention is designed to cool an energy storage unit, for example a battery pack of a motor vehicle. An energy storage unit of this type comprises electrical energy storage cells, which in this case constitute a first portion and a second portion of the energy storage unit. These two portions are positioned respectively, within the thermal regulation device, on a first thermal regulation stage and a second thermal regulation stage which are in fluidic communication; in this case, this means that the first stage and the second stage have the same cooling fluid passing through them. These first and second stages are in this case offset in a vertical direction of stacking, the second stage being superimposed on the first stage in this direction.

The second stage can have a similar structure, with a second support plate and a second distribution plate.

Each of the stages comprises a substantially flat support plate, and a locally deformed distribution plate, which create between them channels for circulation of the cooling fluid, in order to cool the corresponding stage of the thermal regulation device. According to the invention, the support plate of the first stage, or first support plate, is also positioned against an additional plate, which, like the distribution plate is deformed locally. The first support plate and the additional plates define between them ducts for circulation of the cooling fluid. These ducts for circulation of the cooling fluid, which thus belong to the first stage, permit circulation of the cooling fluid within this first stage, however without it being allocated to cooling of the electrical energy storage cells which are positioned on this first stage. These circulation ducts consist of a fluid supply duct, which participates in bringing the cooling fluid to the second stage, and a fluid discharge duct, which participates in discharging the cooling fluid from the thermal regulation device.

The additional plate is positioned on a portion of the first support plate which is without electrical energy storage cells. It thus constitutes a bypass circuit for the cooling fluid within the first stage, in relation to the distribution plate of this first stage, or first distribution plate. The additional plate participates in assuring fluidic communication between the first stage and the second stage, in the sense that the cooling fluid which circulates within the ducts for circulation of the cooling fluid of the additional plate, i.e. within the first stage, is designed subsequently to circulate within the second stage, and thus to cool the electrical energy storage cells of the second stage.

The additional plate is in fluidic communication with a connection means, which participates in circulating cooling fluid of the first stage to the second stage, and conversely from the second stage to the first stage.

The thermal regulation device according to the invention thus makes it possible to assure that all of the energy storage unit which it equips is correctly cooled. Without this additional plate, the connection means would be connected to the channels for circulation of cooling fluid, and the cooling fluid reaching the second stage would be heated too much after having regulated the first portion of the electrical storage unit positioned on the first stage, and it could not assure optimal cooling of the second portion of this electrical storage unit positioned on the second stage.

According to another characteristic of the invention, the connection means comprises two vertical tubes. The additional plate is configured to communicate with the connection means, such that the plate is in line with the supply of cooling fluid of the second stage, and can adopt the form of rigid straight tubes.

One of the tubes forms a tube for supply of cooling fluid to the second stage, and the other one of the tubes forms a tube for discharge of the second stage.

According to a characteristic of the invention, the tubes are positioned between the first support plate and the second stage.

According to another characteristic of the invention, the tubes are positioned between the additional plate and the second stage.

This solution can be preferable when the tubes can not be placed in the interior of the casing, in order to facilitate the peripheral sealing between the support plate and the structural frame.

It is understood in this case that there are a plurality of embodiments of the present invention, which differ from one another in the connection of the connection means on the first stage, i.e. a connection directly on the additional plate and the duct for circulation of the cooling fluid which it participates in forming, or an indirect connection via a bypass channel formed on the first stage, connecting the additional plate to the connection means.

According to one characteristic, the additional plate has a first end and a second end which are opposite in a main direction of extension of the additional plate, with at least a first end being positioned against the first support plate facing at least one proximal orifice provided in the first support plate, with the additional plate communicating through this proximal orifice with a proximal bypass channel formed by a protuberance of the first distribution plate, and forming a bypass of the channels for circulation of the cooling fluid.

The orifice which is provided in the first support plate allows the cooling fluid to go from one side to the other of the first support plate. More specifically, the cooling fluid is made to pass through the first support plate in order to circulate in a first stage facing a face of this first support plate and of the first distribution plate, and in a second stage facing another face of the first support plate and the additional plate, and conversely.

According to a characteristic of the invention, the additional plate is in fluidic communication at its second end with the second stage and the connection means by means of at least one distal bypass channel formed by a protuberance of the first distribution plate, a first end of which covers one of the orifices which is covered on the other side of the first support plate by the additional plate, with the connection means also opening into the bypass channel at a second end thereof.

It is understood that a characteristic of this type corresponds in particular to the embodiment wherein the tubes connect the first support plate and the second support plate.

According to an alternative characteristic of the invention, the additional plate is in direct fluidic communication with the connection means, by means of two perforations provided in the second end of the additional plate, in a face of the additional plate opposite the first support plate.

Thus, in this particular embodiment, the cooling fluid can circulate between a circulation duct provided within the additional plate, and the connection means, without following a bypass channel for this purpose.

According to one characteristic, the additional plate comprises two ducts for circulation of the cooling fluid, extending in the vicinity of one another in a central position of the first stage, including a duct for supply of cooling fluid and a duct for discharge of the cooling fluid.

These two circulation ducts have the same dimensions and are parallel to one another. They allowed the cooling fluid to be conveyed from one end to the other of the additional plate; more specifically, the duct for supply of cooling fluid permits circulation of the cooling fluid from the first end to the second end, and conversely the duct for discharge of the cooling fluid permits circulation thereof from the second end to the first.

In certain alternative embodiments, they are offset to one side.

According to an alternative characteristic of the invention, the additional plate is formed by two distinct parts, including a first additional plate and a second additional plate extending along opposite edges of the first support plate.

This constitutes a variant embodiment, in which the thermal regulation device comprises two distinct additional plates positioned spaced from one another, in order to provide the fluidic communication between the first stage and the second stage. These two additional plates are symmetrical relative to one another on a plane which passes via a middle of the thermal regulation device. They follow the contours of the first support plate; it is thus understood that they are positioned on the first face on the periphery of this support plate, along opposite edges of the support plate. In other words, a first additional plate extends in particular along a lateral edge of the support plate, and the second additional plate extends in particular along an opposite lateral edge, optionally in parallel, of the support plate.

According to another characteristic of the invention, the first additional plate and the second additional plate each comprise a duct for circulation of the cooling fluid, with the duct for circulation of the cooling fluid of the first additional plate being a duct for supply of cooling fluid, and the duct for circulation of the cooling fluid of the second additional plate being a duct for discharge of the cooling fluid.

It is thus understood that the first additional plate is responsible for supplying the second stage with cooling fluid, whereas the second additional plate makes it possible to discharge this cooling fluid once it has regulated the temperature of the second portion of the energy storage unit associated with this second stage.

According to a characteristic of the invention, the ducts for circulation of cooling fluid delimited by the additional plate have a constant cross-section for passage of fluid from a first end of the additional plate to the second end of the additional plate, with this cross-section being measured on a plane perpendicular to the main direction of extension of the additional plate.

According to one characteristic, the cross-section of passage of fluid of the ducts for circulation of cooling fluid delimited by the additional plate is identical to a cross-section of passage of fluid of the channels for circulation of cooling fluid provided within the first stage, between the first support plate and the first distribution plate. This constant cross-section participates in assuring a similar flow of cooling fluid for the circulation of fluid within the first stage and that within the second stage of the thermal regulation device, and therefore participates in assuring homogeneous thermal regulation of the energy storage unit irrespective of the stage concerned.

According to one characteristic, the plates which form the first stage and the second stage and the additional plate are made of the same material.

An identical nature of this type of the materials facilitates the production of the thermal regulation device according to the invention.

According to a characteristic of the invention, the plates which form the first stage and the second stage and the additional plate are made of aluminum.

In particular, the plates of the thermal regulation device can be assembled by brazing. Optionally, the aluminum is covered by a material which facilitates this brazing.

According to one characteristic, the plates which form the first stage and the second stage and the additional plate are made of a composite material.

This composite material complies with ecological considerations by having a reduced carbon footprint in comparison with aluminum. It also has a reduced mass. The composite material can in particular be associated with plastic.

Other characteristics, details and advantages of the invention will become more clearly apparent from reading the following description, and from studying the embodiments given by way of non-limiting illustration, with reference also to the appended drawings, in which:

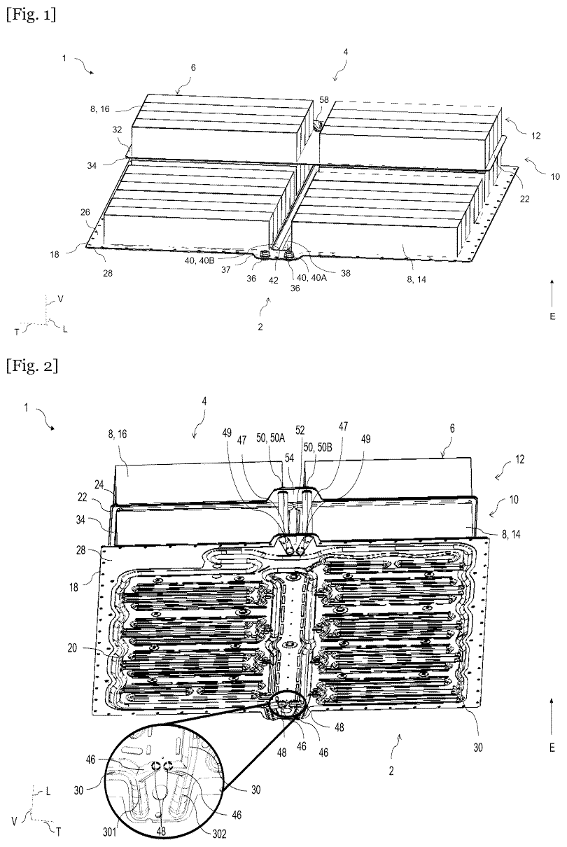

FIG. 1 illustrates schematically and seen in perspective a thermal regulation device according to the invention, with two regulation stages, according to a first embodiment;

FIG. 2 illustrates schematically the thermal regulation device of FIG. 1 according to another angle of perspective showing the underneath of the device;

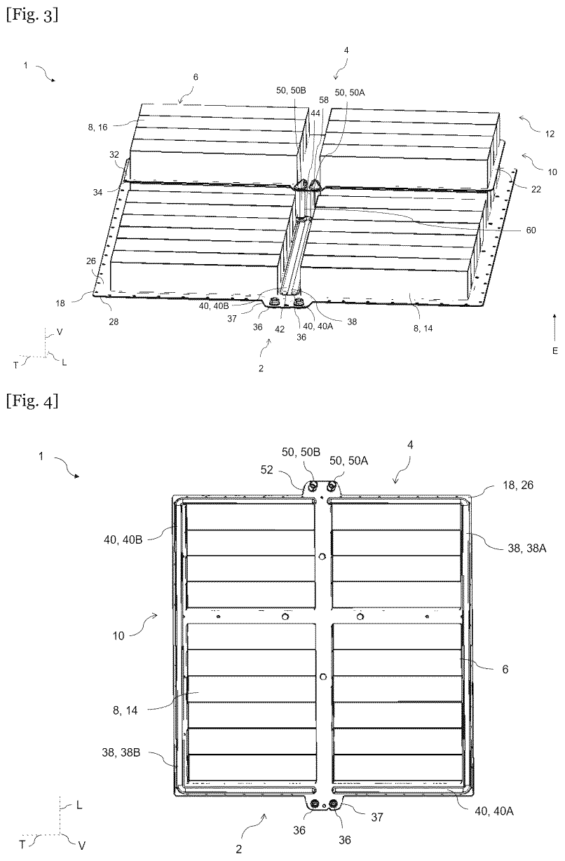

FIG. 3 illustrates schematically a thermal regulation device according to a second embodiment, according to a view in perspective similar to that of FIG. 1;

FIG. 4 illustrates schematically a thermal regulation device according to a third embodiment, seen from above;

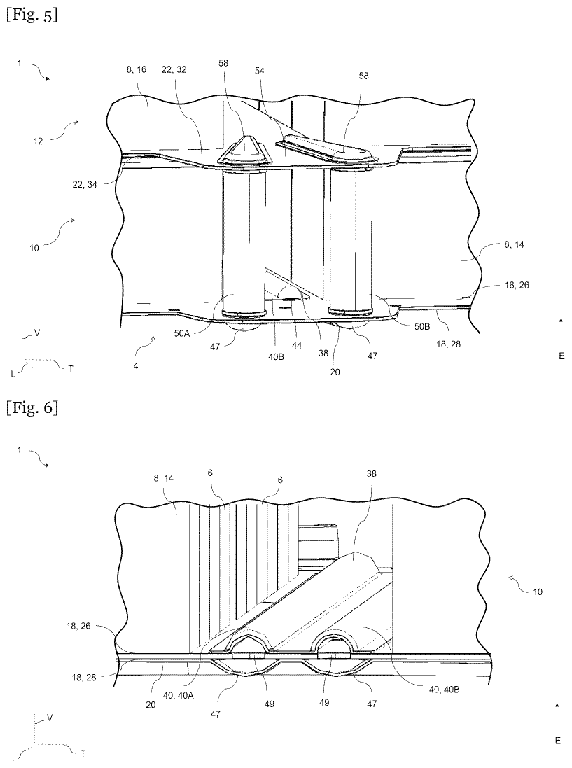

FIG. 5 illustrates schematically the thermal regulation device of FIGS. 1 and 2 according to a viewing angle which shows an additional plate and a connection means for the fluidic communication between the two stages of the thermal regulation device;

FIG. 6 illustrates schematically the additional plate of the thermal regulation device of FIGS. 1 and 2 according to a cross-sectional view which shows the fluidic communication between a duct delimited by the additional plate and a bypass channel, via an orifice formed in a support plate of the first stage;

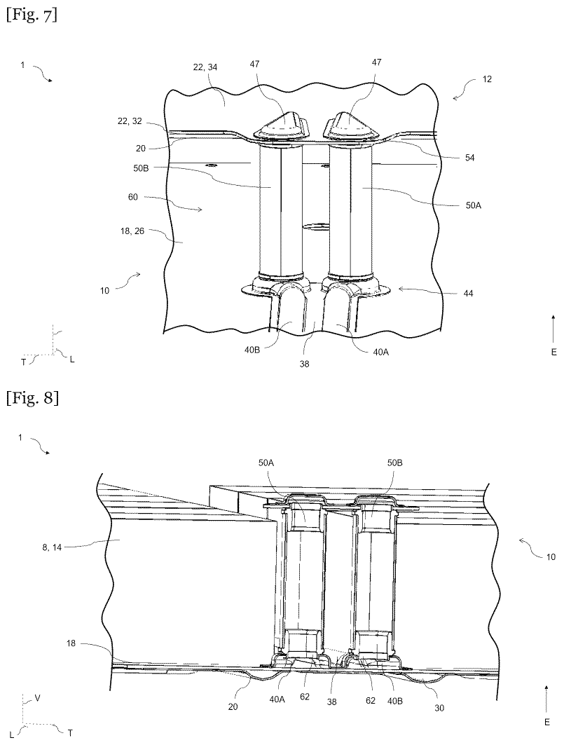

FIG. 7 illustrates schematically a connection means of the thermal regulation device of FIG. 3;

FIG. 8 illustrates schematically the connection means of FIG. 7 according to a cross-sectional view;

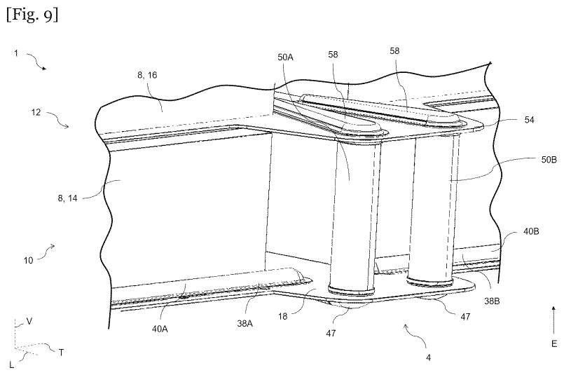

FIG. 9 illustrates schematically a connection means of the thermal regulation device of FIG. 4 according to a view in perspective.

The characteristics, variants and different embodiments of the invention may be associated with one another in various combinations, provided that they are not mutually incompatible or exclusive. In particular, variants of the invention may be conceived of comprising only a selection of characteristics described hereinafter in isolation from the other characteristics described, if this selection of characteristics is sufficient to confer a technical advantage and/or to differentiate the invention from the prior art.

In the figures, elements that are common to multiple figures retain the same reference sign.

In the detailed description which follows, the denominations “longitudinal”, “transverse” and “vertical” refer to the orientation of the thermal regulation device according to the invention. A longitudinal direction corresponds to a main direction of extension of this thermal regulation device, this longitudinal direction being parallel to a longitudinal axis L of a coordinate system L, V, T illustrated in the figures. A vertical direction corresponds to a direction of stacking of the first stage and the second stage, this vertical direction being parallel to a vertical axis V of the coordinate system L, V, T, and this vertical axis V being perpendicular to the longitudinal axis L. Finally, a transverse direction corresponds to a direction parallel to a transverse axis T of the coordinate system L, V, T, this transverse axis T being perpendicular to the longitudinal axis L and to the vertical axis V.

In addition, in the present description, the term “cooling fluid” can relate to any heat-transfer, coolant, thermal regulation, dielectric or biphasic fluid, provided that this liquid or gaseous fluid has the effect of cooling or heating electrical energy storage units.

FIGS. 1 and 2 thus illustrate schematically a thermal regulation device 1 according to the invention according to a first embodiment, respectively in a view from above and a view from below. The thermal regulation device 1 extends mainly in a direction of extension which corresponds to a longitudinal direction, from a first longitudinal end 2 to a second longitudinal end 4.

The thermal regulation device 1 is designed to equip a vehicle, for example a motor vehicle, in order to regulate a temperature of an energy storage unit 6 of this vehicle by means of a cooling fluid. The energy storage unit 6 is for example composed of a plurality of electrical energy storage cells 8 which are designed to be cooled or heated thanks to the cooling fluid. The energy storage unit 6 comprises different levels of electrical energy storage cells, which are offset from one another in a vertical direction, i.e. perpendicularly to the ground on which the vehicle equipped with the thermal regulation device 1 is standing, in particular in order to incorporate a maximum number of electrical energy storage cells in a defined space of the motor vehicle.

In this context, the thermal regulation device 1 has a first stage 10 and a second stage 12 on which the electrical energy storage cells 8 are distributed. The first stage 10 and the second stage 12 are superimposed in a vertical direction of stacking E. “Superimposed” in this case means that the second stage 12 is positioned above the first stage 10 in this vertical direction of stacking E. As shown in particular in FIG. 1, the second stage 12 has dimensions smaller than the first stage 10, such that it receives a smaller number of electrical energy storage cells 8. The second stage 12 is thus offset in relation to the first stage 10 in the longitudinal direction, in the sense that, unlike this first stage 10, it does not extend from the first longitudinal end 2 of the thermal regulation device 1 to its second longitudinal end 4.

The electrical energy storage cells 8 of the energy storage unit 6 are divided into two portions 14, 16, including a first portion 14 and a second portion 16. The first portion 14 of the energy storage unit 6 is positioned on the first stage 10, whereas its second portion 16 is positioned on the second stage 12. The electrical energy storage cells 8 which form the first portion 14 are distributed on the first stage 10 of the thermal regulation device 1 from its first longitudinal end 2 as far as its second longitudinal end 4, in two substantially symmetrical rows along a longitudinal-vertical plane. The electrical energy storage cells 8 which form the second portion 16 can be distributed on the second stage 12 according to an equivalent configuration, without this limiting the present embodiment.

The thermal regulation of the first and second portions 14, 16 of the energy storage unit 6, and more particularly their cooling, is assured by the circulation of a cooling fluid within the thermal regulation device 1. The first stage 10 and the second stage 12 comprise for this purpose a support plate and a distribution plate each. The first stage 10 thus has a first support plate 18 and a first distribution plate 20, with the second stage 12 for its part comprising a second support plate 22 and a second distribution plate 24.

The first support plate 18 comprises a first face 26 and a second face 28 opposite one another in the vertical direction of stacking E. The first face 26 is in contact with the electrical energy storage cells 8 of the first portion 14, whereas the second face 28 is facing the first distribution plate 20. The two faces 26, 28 of the first support plate 18 are substantially flat, i.e. they do not have any roughness. On the other hand, the first distribution plate 20 is deformed locally, such that it has a network of protuberances going away from the first support plate 18. These protuberances of the first distribution plate 20 define between one another and the second face 28 of the first support plate 18 channels for circulation of the cooling fluid 30, within which the cooling fluid circulates for the thermal regulation of the first portion 14 of the electrical energy storage cells 8 associated with the first stage 10. These channels for circulation of the cooling fluid 30 of the first distribution plate 20 are shown in particular in FIG. 2.

Similarly, the second support plate 22 comprises a first surface 32 and a second surface 34 opposite one another in the vertical direction of stacking E. The first surface 32 is in contact with the electrical energy storage cells 8 of the second portion 16, whereas the second surface 34 is facing the second distribution plate 24. The two surfaces 32, 34 of the second support plate 22 are substantially flat, i.e. they do not have any roughness. On the other hand, the second distribution plate 24 is deformed locally, in order to form, between the second distribution plate and the second surface 34 of the second support plate, other channels for circulation of the cooling fluid within which this cooling fluid circulates, this time for the thermal regulation of the second portion 16 of the electrical energy storage cells 8 associated with the second stage 12. In FIG. 2, the channels for circulation of the cooling fluid of the second distribution plate 24 are masked by the electrical energy storage cells 8 of the first stage 10.

In order to convey the cooling fluid to the thermal regulation device 1 and to discharge it therefrom, the thermal regulation device 1 has connection joining pieces 36. These connection joining pieces 36 are positioned at the first longitudinal end 2 of the thermal regulation device 1, i.e. its end which is not covered by the second stage 12. In this case, the thermal regulation device 1 comprises a connection joining piece 36 corresponding to a cooling fluid inlet and a connection joining piece 36 corresponding to a cooling fluid outlet. In the example illustrated, these connection joining pieces 36 are positioned on a portion of the first longitudinal end 2 which corresponds to a longitudinal protuberance 37. The connection joining pieces are each positioned facing a hole formed in the support plate, in order to communicate respectively with a supply branch 301 and a discharge branch 302 which are connected to the channels for circulation of the cooling fluid 30 within the first stage 10. At least part of the cooling fluid which goes into the thermal regulation device then passes in succession via a first connection joining piece 36, the supply branch 301, the network of channels for circulation of the cooling fluid 30 within the first stage 10, then via the discharge branch 302 in order to be discharged from the thermal regulation device via the second connection joining piece 36.

In some embodiments, the first support plate 18 is flat.

According to the invention, the thermal regulation device 1 comprises at least one additional plate 38 and a connection means which make it possible to shunt part of the cooling fluid which goes into the thermal regulation device, in order to direct it to the second stage of this thermal regulation device.

The additional plate 38 is positioned on the first support plate 18 on its first face 26, i.e. opposite the first distribution plate 20. Like this first distribution plate 20, the additional plate 38 is deformed locally and has protuberances which define between one another and the first face 26 of the first support plate 18 at least one duct for circulation of the cooling fluid 40.

The additional plate 38, which in particular is associated with the connection means 50 which will be described hereinafter, permits fluidic communication between the first stage 10 and the second stage 12. More specifically, this additional plate 38 permits the passage of part of the cooling fluid from the first stage 10 to the second stage 12, without the temperature of this cooling fluid going into the second stage 12 being completely modified by the prior thermal regulation of the first portion 14 of the energy storage unit 6 positioned on this first stage 10. It is understood that the additional plate 38 constitutes for the cooling fluid a bypass in relation to the first distribution plate 20, before being conveyed to the second distribution plate 24.

The additional plate 38 and the plates which also form the first stage, i.e. the first support plate 18 and the first distribution plate 20, can advantageously be made of the same material. A single material of this type can, according to variants of the present invention, be aluminum, or also a composite material, which for example is made of plastic.

In the figures, the additional plate 38 and the associated connection means are represented according to different embodiments. FIGS. 1, 2, 5 and 6 thus correspond to a first embodiment, FIGS. 3, 7 and 8 correspond to a second embodiment, and finally FIGS. 4 and 9 correspond to a third embodiment. These embodiments will now be described in succession.

The additional plate 38 according to the first embodiment extends from the first longitudinal end 2 of the thermal regulation device 1 to its second longitudinal end 4. It is positioned substantially in the middle of the first support plate 18 in the longitudinal direction, i.e. along a longitudinal-vertical plane which divides the thermal regulation device 1 into two symmetrical parts. It is thus understood that the additional plate 38 is positioned between the two rows of electrical energy storage cells 8 which constitute the first portion 14.

Again according to this first embodiment, the additional plate 38 has a first end 42 positioned in the vicinity of the first longitudinal end 2 of the thermal regulation device 1, and a second end 44 opposite this first end 42, which is thus in the vicinity of the second longitudinal end 4 of this thermal regulation device 1. The additional plate 38 is in this case substantially straight from its first end 42 to its second end 44.

As shown in particular in FIG. 6, the additional plate 38 comprises two ducts for circulation of the cooling fluid 40. More particularly, the additional plate 38 comprises, in respect of these ducts for circulation of the cooling fluid 40, a duct for supply of cooling fluid 40A and a duct for discharge of cooling fluid 40B. The duct for supply of cooling fluid 40A and the duct for discharge of the cooling fluid 40B have cross-sections of passage, i.e. surfaces measured on a plane perpendicular to the longitudinal direction, which are identical to one another and constant from one end to the other of the additional plate. A cross-section of this type of the ducts for circulation of the cooling fluid 40 can advantageously be identical to a cross-section of the channels for circulation of the cooling fluid 30 formed within the first stage 10 and/or within the second stage 12.

The cooling fluid circulates within these two ducts for supply and discharge of the cooling fluid 40A, 40B in two opposite directions. The first end 42 of the additional plate 38 is for this purpose positioned at the first longitudinal end 2 of the thermal regulation device 1, such that the duct for supply of cooling fluid 40A is facing, in the longitudinal direction, the connection joining piece 36 which corresponds to an inlet for cooling fluid within the thermal regulation device 1, and the duct for discharge of the cooling fluid 40B is facing, in the longitudinal direction, the connection joining piece 36 which is an outlet for cooling fluid.

The duct for supply of cooling fluid 40A and the duct for discharge of the cooling fluid 40B are however not connected directly to the connection joining pieces 36. As shown in FIG. 2, the cooling fluid circulates between a connection joining piece 36 and the duct for supply of cooling fluid 40A by means of a first proximal bypass channel 46, which diverges from the supply branch 301, and between the duct for discharge of cooling fluid 40B and a connection joining piece 36 by means of a second proximal bypass channel 46, which converges towards the discharge branch 302. These proximal bypass channels 46 are, like the channels for circulation of cooling fluid 30, formed by protuberances from the first distribution plate 20. They make it possible to form a parallel circuit in which there circulates a portion of the cooling fluid diverted from the channels for circulation of cooling fluid 30 associated with the first stage 10. In other words, when cooling fluid is conveyed to the first distribution plate 20, a portion of this fluid is destined to circulate in the channels for circulation of the cooling fluid 30 of the first stage 10, whereas another portion is destined to follow these proximal bypass channels 36, in order to be conveyed to the additional plate 38, then to the second stage 12. Once the fluid which has circulated within the second stage and has recuperated calories from, or yielded them to, the second portion 16 of the energy storage unit 6, the diverted portion of cooling fluid is re-injected into the channels for circulation of cooling fluid just before opening onto the connection joining piece 36 corresponding to the joining piece for discharge of cooling fluid.

In order to permit the passage of cooling fluid through the first support plate 18, so as to pass from the circulation channels 30, between the second face 28 of the first support plate 18 and the first distribution plate 20, to a circulation duct 40 between the first face 26 of the first support plate and the additional plate 38, and in order to permit the passage in the inverse direction from a circulation duct to the circulation channels 30, the first support plate 18 has proximal orifices 48 which pass through it from one side to the other, i.e. which open out both onto its first face 26 and onto its second face 28. These proximal orifices 48 are provided in the first support plate 18, at the first end 42 of the additional plate 38, such that a proximal orifice 48 opens into the duct for supply of cooling fluid 40A, and a proximal orifice 48 opens into the duct for discharge of the cooling fluid 40B. Proximal orifices 48 of this type are in particular shown schematically in broken lines in FIG. 2.

Again according to the first embodiment, the second end 44 of the additional plate 38, which is the one facing the second longitudinal end 4 of the thermal regulation device 1, is positioned below the second stage 12. The additional plate 38 is connected fluidically to this second stage 12 by means of a connection means, which is shown in particular in FIGS. 2 and 5. In this case, a connection means of this type takes the form of two tubes 50 which are rigid and straight. These tubes 50 are vertical, i.e. substantially perpendicular both to the first stage 10 and to the second stage 12. In this case, the tubes 50 are positioned between the first support plate 18, and in particular the first face 26 of this first support plate, and the second support plate 22. These tubes 50 comprise a first tube 50A and a second tube 50B, with the first tube 50A being positioned facing, in the longitudinal direction, the duct for supply of cooling fluid 40A, whereas the second tube 50B is positioned facing the duct for discharge of the cooling fluid 40B in this longitudinal direction. It is understood that the first tube 50A participates in supplying the second stage with cooling fluid, and in this case circulation channels provided between the second support plate 22 and the second distribution plate 24, from the cooling fluid circulating within the additional plate 38, and more particularly its duct for supply of cooling fluid 40A, with the second tube 50B for its part being designed for the discharge of the cooling fluid of the second stage 12 by means of the duct for discharge of the cooling fluid 40B.

In this first embodiment, and as described for the connection joining pieces 36, the tubes 50 do not open directly into the additional plate 38. In order to go from the ducts delimited by the additional plate 38 to these tubes 50, the cooling fluid thus follows distal bypass channels 47, formed by protuberances of the first distribution plate 20, like the proximal bypass channels 46 positioned at the first end 42. A distal bypass channel 47 connects fluidically the duct for supply of cooling fluid 40A and the first tube 50A, and a distal bypass channel 47 connects fluidically the duct for discharge of the cooling fluid 40B and the second tube 50B.

In order to permit this fluidic communication, each distal bypass channel 47 extends between a distal orifice 49 provided in the first support plate 18 between the second end 44 of the additional plate and a corresponding distal bypass channel, and a connection orifice 51, provided in the first support plate 18 between the tube 50A, 50B and the corresponding distal bypass channel. The distal orifices 49 and the connection orifices 51 are represented in broken lines in FIG. 2, and the distal orifices can be seen in particular in the view in cross-section of FIG. 6. It is understood that, like the proximal orifices 48 positioned in the vicinity of the first end 42 of the additional plate, these distal orifices 49 and these connection orifices permit the passage of the cooling fluid from one side to the other of the first support plate 18.

The distal bypass channels 47 of the second end 44 are connected to the tubes 50 at a projection 52 of the first support plate 18, in which in this case the distal orifices are thus provided. This projection 52 is facing, in the vertical direction of stacking E, a tongue 54 of the second support plate 22 which extends cantilevered from the second stage 12, in order to be in line with the projection 52. It is understood that the protuberance 37, the projection 52 and the tongue 54 make it possible to position the connection joining pieces and the connection tubes on the periphery of the stages of the thermal regulation device, in order not to reduce the surface area of exchange of heat with the energy storage unit 6.

The tongue 54 is pierced by two through holes, not illustrated in the figures, each permitting communication of channels for cooling fluid of the second stage with one of the first and second tubes 50A, 50B. For this purpose, covers 58, as shown in FIG. 1, are configured to guide the cooling fluid, with a function similar to that of the bypass channels 46, 47 of the first distribution plate 20, in that they each permit the passage of the cooling fluid from one face 26 to the other face 28 of the support plate 18 of the first stage 10, or from one surface 32 to the other surface 34 of the support plate 22 of the second stage 12.

It is understood from the foregoing that, in order to circulate within the second stage 12, the cooling fluid enters the thermal regulation device 1 via the connection joining piece 36 which corresponds to an input at the first longitudinal end 2 of the thermal regulation device 1. The cooling fluid circulates through the supply branch 301, then part of this cooling fluid circulates in one of the proximal bypass channels 46, and passes through one of the proximal orifices 48 of the first support plate 18, in order to open into the duct for supply of cooling fluid 40A of the additional plate 38. The cooling fluid which is present in this supply duct 40A can then circulate within the first stage 10, without being allocated to the cooling of these electrical energy storage cells 8 positioned within this first stage 10, with cooling of this type being carried out in parallel by the part of the cooling fluid which is not diverted into the proximal bypass channel previously described, and circulates within channels for circulation of the cooling fluid 30 delimited between the first support plate 18 and the first distribution plate 20. When it reaches the second end 44 of the additional plate 38, the cooling fluid which is present in this supply duct 40A passes through one of the distal orifices 49 of the first support plate 18, such as to circulate in one of the distal bypass channels 47. This distal bypass channel 47 opens into the first tube 50A, which participates in forming the connection means between the first stage 10 and the second stage 12. Within this second stage 12, the cooling fluid circulates as close as possible to the second portion 16 of the energy storage unit 6, in this case between the second support plate 22 and the second distribution plate 24, in order to cool this second portion 16 of the energy storage unit 6.

The cooling fluid is then discharged from the second stage by means of the second tube 50B, passing for this purpose via one of the through holes provided in the tongue 54. After having passed through the first support plate 18, the cooling fluid circulates in the distal bypass channel 47, facing the second face 28 of the first support plate 18, as far as the duct for discharge of the cooling fluid 40B of the additional plate 38, which it reaches via the other distal orifice 49 provided in the first support plate 18. The cooling fluid then circulates along the first face 26 of the first support plate 18, within the additional plate 38, from its second end 44 as far as its first end 42, then passes into the other proximal bypass channel 46 situated at this first end 42, via the other proximal orifice 48. It can then reach the connection joining piece 36 which is dedicated to the discharge, and then leave the thermal regulation device 1.

The second embodiment of the present invention will now be described, this second embodiment being illustrated in FIGS. 3, 7 and 8. The thermal regulation device 1 according to the second embodiment differs from the thermal regulation device 1 according to the first embodiment in that the connection means, in the form of the tubes 50 which connect fluidically the first stage 10 and the second stage 12, is no longer positioned in the vicinity of the second longitudinal end 4 of the thermal regulation device 1. Thus, and as shown in particular in FIG. 3, these tubes 50 are positioned among the electrical energy storage cells 8, between the first longitudinal end 2 and the second longitudinal end 4, within a central area 60 of the thermal regulation device 1. This central area 60 is in this case not illustrated equidistantly from the first and second longitudinal ends 2, 4, but closer to the second longitudinal end 4. However, it is understood that other arrangements of the tubes 50 between the first longitudinal end 2 and the second longitudinal end 4 are possible. The arrangement of the tubes 50 is dependent on the longitudinal dimension of the second stage 12, with these tubes 50 extending vertically and opening in the vicinity of a longitudinal end of this second stage 12.

In this second embodiment, as a result of the particular arrangement of the tubes 50, the additional plate 38 has a dimension, measured in the longitudinal direction, which is reduced in relation to that of the additional plate 38 of the first embodiment. This additional plate 38 in this case extends from the first longitudinal end 2, where its first end 42 is located, to the tubes 50, where its second end 44 is located.

As can be seen in particular in FIGS. 3 and 7, the tongue 54 is no longer cantilevered in relation to the projection 52 in the vertical direction of stacking E; it is now oriented towards the first longitudinal end 2 of the thermal regulation device 1, such that it overhangs the additional plate 38, and more specifically its second end 44.

The thermal regulation device 1 according to the second embodiment also differs from the first embodiment in that the tubes 50 are connected directly to the additional plate 38. In other words, the tubes 50 are positioned between the second stage 2 and this additional plate 38, as can be seen in particular in FIGS. 7 and 8.

The tubes 50 open into the additional plate 38 by means of perforations 62 provided in this additional plate 38. The additional plate 38 has more specifically a perforation 62 provided on its duct for supply of cooling fluid 40A, and a perforation 62 provided on its duct for discharge of the cooling fluid 40B, as illustrated in FIG. 8. The perforation 62 positioned on the duct for supply of cooling fluid 40A is connected to the first tube 50A, whereas the perforation 62 positioned on the duct for discharge of the cooling fluid 40B is connected to the second tube 50B. Because of these perforations 62, the cooling fluid circulates directly from the circulation ducts 40 formed in the additional plate 38, to the tubes of the connection means 50, without needing to pass through the first support plate 18 in order to circulate in a bypass channel. The distal orifices and distal bypass channels of the first embodiment are thus absent from the thermal regulation device according to the second embodiment. Apart from this exception, the circulation of the cooling fluid within the thermal regulation device, from one connection joining piece to the other, with a portion of the cooling fluid diverted through the additional plate in order to supply the second stage, remains the same as that described for the first embodiment.

The third embodiment will now be described with reference to FIGS. 4 and 9. In this third embodiment, the thermal regulation device 1 comprises a first additional plate 38A and a second additional plate 38B. These first and second additional plates 38A, 38B each extend on the periphery of the first support plate 18, and no longer centrally, as was the case in the first two embodiments. The first additional plate 38A and the second additional plate 38B are symmetrical on the longitudinal-vertical plane which divides the thermal regulation device 1 into two substantially equal parts.

Unlike the first and second embodiments, the additional plates 38A, 38B of the third embodiment comprise only a single duct for circulation of the cooling fluid 40. Thus, the first additional plate 38A delimits a duct for supply of cooling fluid 40A, whereas the second additional plate 38B delimits a duct for discharge of the cooling fluid 40B. It is thus understood that the first additional plate 38A serves the purpose of conveying the cooling fluid to the second stage 12, with the second additional plate 38B being dedicated to the discharge thereof, once it has cooled the electrical energy storage cells 8 positioned on this second stage 12.

These additional plates 38A, 38B are thus not straight as for the first two embodiments, but they have bends at substantially right-angles, such as to follow the peripheries of the first support plate 18 which is rectangular, and in particular its corners. Each of the additional plates 38A, 38B thus comprises a first portion which extends along the first longitudinal end 2 of the thermal regulation device 1, a second portion which extends along the second longitudinal end 4, and a third portion which connects these first and second portions, and extends in the longitudinal direction.

The other characteristics described for the first embodiment, and in particular those of these characteristics which relate to the connection means, apply to this third embodiment, provided that they are not incompatible therewith. For example, and as shown in FIG. 9, in this third embodiment, the connection means is positioned at the 25 second longitudinal end 4 of the thermal regulation device 1, and the tubes 50 which constitute it are positioned facing the first and second additional plates 38A, 38B, with the first tube 50A facing the first additional plate 38A, and the second tube 50B facing the second additional plate 38B. The first tube 50A and the second tube 50B each open into a distal bypass channel 47, making it possible to connect them fluidically respectively to the first additional plate 38A and to the second additional plate 38B.

The present invention thus proposes a thermal regulation device which can cool a first stage and a second stage of a single energy storage unit with a single closed cooling fluid circuit, with the presence of an additional plate added onto the face of the first stage making it possible to divert part of the cooling fluid, and direct it to the second stage, without its temperature being unfavorably modified by exchange of heat with cells of an energy storage unit during its circulation along the first stage.

The present invention is however not limited to the means and configurations described and illustrated here, and also extends to all equivalent means and configurations and to any technically operational combination of such means.

1. A thermal regulation device for cooling of an energy storage unit by a cooling fluid, comprising:
a first stage configured to be in contact with a first portion of the energy storage unit;
a second stage configured to be in contact with a second portion of the energy storage unit,
wherein the second stage is at least partly offset in relation to the first stage in a vertical direction of stacking,
wherein the first stage comprising:
a first support plate; and
a first distribution plate,
wherein the first support plate having a first face which is designed to be in contact with the energy storage unit, and a second face opposite this first face,
wherein the first distribution plate is in contact with the second face, and is deformed locally such as to delimit channels for circulation of the cooling fluid; and
at least one additional plate positioned against the first face of the first support plate, and delimiting at least one duct for circulation of the cooling fluid,
wherein the first stage and the second stage being in fluidic communication via the at least one additional plate and a connection means.

2. The thermal regulation device as claimed in claim 1, wherein the connection means comprises two vertical tubes.

3. The thermal regulation device as claimed in claim 2, wherein the two vertical tubes are positioned between the first support plate and the second stage.

4. The thermal regulation device as claimed in claim 2, wherein the two vertical tubes are positioned between the at least one additional plate and the second stage.

5. The thermal regulation device as claimed in claim 1,
wherein the at least one additional plate has a first end and a second end which are opposite in a main direction of extension of the at least one additional plate,
wherein the first end is positioned against the first support plate facing at least one proximal orifice provided in the first support plate,
wherein the at least one additional plate communicating through this proximal orifice with a proximal bypass channel formed by a protuberance of the first distribution plate, and forming a bypass of the channels for circulation of the cooling fluid.

6. The thermal regulation device as claimed in claim 5, wherein the at least one additional plate is in fluidic communication at the second end with the second stage and the connection means by at least one distal bypass channel formed by a protuberance of the first distribution plate, a first end of which covers one of the orifices of the first support plate which is covered on the other side of the first support plate by the at least one additional plate, with the connection means also opening into the at least one distal bypass channel at a second end thereof.

7. The thermal regulation device as claimed in claim 5,
wherein the at least one additional plate is in direct fluidic communication at its second end with the connection means, by at least one perforation provided in the second end of the at least one additional plate, in a face of the at least one additional plate opposite the first support plate.

8. The thermal regulation device as claimed in claim 1, wherein the at least one additional plate comprises:
two ducts for circulation of the cooling fluid, extending in a vicinity of one another in a central position of the first stage,
wherein the two ducts include a duct for supply of cooling fluid and a duct for discharge of the cooling fluid.

9. The thermal regulation device as claimed in claim 1, wherein the at least one additional plate is formed by two distinct parts, including a first additional plate and a second additional plate extending along opposite edges of the first support plate.

10. The thermal regulation device as claimed in claim 9, wherein a cross-section of passage of fluid of the at least one duct for circulation of cooling fluid delimited by the at least one additional plate is identical to a cross-section of passage of fluid of the channels for circulation of the cooling fluid provided within the first stage, between the first support plate and the first distribution plate.
